(19) United States
(12) Patent Application Publication
(10) Pub. No.: US 2021/0248688 A1
(43) Pub. Date: Aug. 12, 2021

(54) LOCALIZED GOVERNMENTAL AND POLITICAL INFORMATION SYSTEMS AND METHODS

(71) Applicant: BY THE PEOPLE, Salt Lake City, UT (US)

(72) Inventor: David Idan Schutt, Salt Lake City, UT (US)

(73) Assignee: BY THE PEOPLE, Salt Lake City, UT (US)

(21) Appl. No.: 17/157,291

(22) Filed: Jan. 25, 2021

Related U.S. Application Data
(60) Provisional application No. 62/965,081, filed on Jan. 23, 2020.

(51) Int. Cl. G06Q 50/00; G06Q 30/02; G06Q 10/10; G06Q 50/26

(52) U.S. Cl. CPC G06Q 50/01; G06Q 50/26; G06Q 10/10; G06Q 30/0201

(57) ABSTRACT

Disclosed herein is a system and a method comprising a processor associated with a server computer which is receiving login information from a device associated with a user including a confirmed address associated with a user. After receiving the login information the processor requests access to a physical location of the device associated with the user. The processor then verifies that the physical location of the device associated with the user is within a predetermined distance from the confirmed address received by the processor associated with the server computer with the login information. Upon verification, the processor identifies one or more voting district associated with the confirmed address. The processor then transmits a message to the device associated with the user with political information relevant to the voting district with the user based on the physical location of the device and the confirmed address.

### CROSS-REFERENCE TO RELATED APPLICATION

This application claims the benefit of U.S. Provisional Application No. 62/965,081, filed Jan. 23, 2020, which is incorporated herein by reference in its entirety, including but not limited to those portions that specifically appear hereinafter.

### TECHNICAL FIELD

The present disclosure relates to systems and methods for facilitating physical location-based governmental and political information which is filtered according to the voting district of the user.

### BACKGROUND

According to Abraham Lincoln, the United States of America is comprised of a government “of the people, by the people, for the people, [and] shall not perish from the earth.” The government of the United States of America rests on the shoulders of the people. To be able to make informed political decisions and to be involved responsibly in the governmental institutions, locally, regionally, and federally it is vital to have access to focused accurate information. Further, informed political decisions require understanding an effect of particular political decisions.

Various government agencies have attempted to make information, such as laws, regulations, policies, and the like freely available to the public. However, there are many layers of government in the United States including, federal, state, county, and city governments, each with separate branches and multiple agencies. Furthermore, each division of government often has their own independent method of making information available to the public. As a result, there is a vast number of different locations ways and methods required to collect relevant voting information. The informational resources available to any particular citizen that also affect their particular location may widely vary in accessibility based on that particular location. As a result, many citizens remain unable to access meaningful information from primary sources and instead rely on reporting in traditional media sources or social media sources, which may include biases. Further, due to the differing information provision systems used by different government agencies, the manner in which the information is accessed can vary, making meaningful access difficult, especially for those with limited technological skills or access.

A system that provides citizens access to relevant localized political information from multiple government agencies and levels is needed. Therefore, one object of this disclosure is to provide a system that provides location-based information relevant to a particular citizen that coincides with the voting district associated with that particular citizen.

### SUMMARY

The present disclosure is directed to a system that includes a processor associated with a server computer which is receiving login information from a device associated with a user including a confirmed address associated with a user. After receiving the login information, the processor requests access to a physical location of the device associated with the user. The processor then verifies that the physical location of the device associated with the user is within a predetermined distance from the confirmed address received by the processor associated with the server computer with the login information. Upon verification, the processor identifies one or more voting district associated with the confirmed address. The processor then transmits a message to the device associated with the user with political information relevant to the voting district with the user based on the physical location of the device and the confirmed address.

The present disclosure also includes a method comprising receiving, by a processor associated with a server computer, login information from a device associated with a user including a confirmed address associated with a user. The processor then request access to a physical location of the device associated with the user. The physical location of the device associated with the user is then verified by the processor to be within a predetermined distance from the confirmed address received by the processor associated with the server computer with the login information. The processer then Identifies one or more voting district associated with the confirmed address. Subsequently the processor transmits a message to the device associated with the user with political information relevant to the voting district with the user based on the physical location of the device and the confirmed address.

### BRIEF DESCRIPTION OF THE DRAWINGS

The accompanying drawings illustrate various embodiments of a multicomputer network.

FIG. 1 illustrates a flowchart for a method of registering a user to provide access to the political information hub.

FIG. 2 illustrates a flowchart for a method of providing different levels of access to the political information hub.

FIG. 3 illustrates an exemplary multicomputer network system that provides a device associated with a user access to political information data.

FIG. 4 illustrates a flowchart for a method of user posted political information to the political information hub.

FIG. 5 illustrates a flowchart for a method of posting and accessing discussions posted to the political information hub.

### DETAILED DESCRIPTION OF THE PREFERRED EMBODIMENTS

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

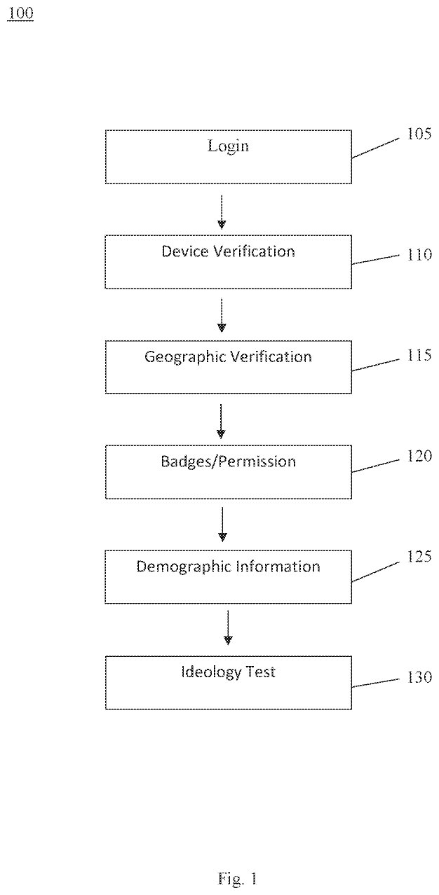

FIG. 1 illustrates a flowchart for a method 100 of registering a user to provide access to a political information hub. Though the flowchart for method 100 is presented in a particular order it should be understood that one or more steps of method 100 can be interchangeable in method 100. Login 105 may also require a date of birth. Alternatively, the question concerning the date of birth may be included later in demographic information 125. Moreover, registration may not be required to visit the political information hub or to download an application of the political information hub. Login 105 may consist of giving a name with a corresponding email address, social media site login, and/or search engine login of the user. One way to verify the user is by a device verification 110.

Device verification 110 includes ensuring the user has access to device and access to the email address, social media site login, and/or search engine used in login 105. This may be done by the server sending a code to the email address, social media site login, and/or search engine listed during the login of the user. After receiving the code, the code may then be input by the user onto the user device to help verify the user.

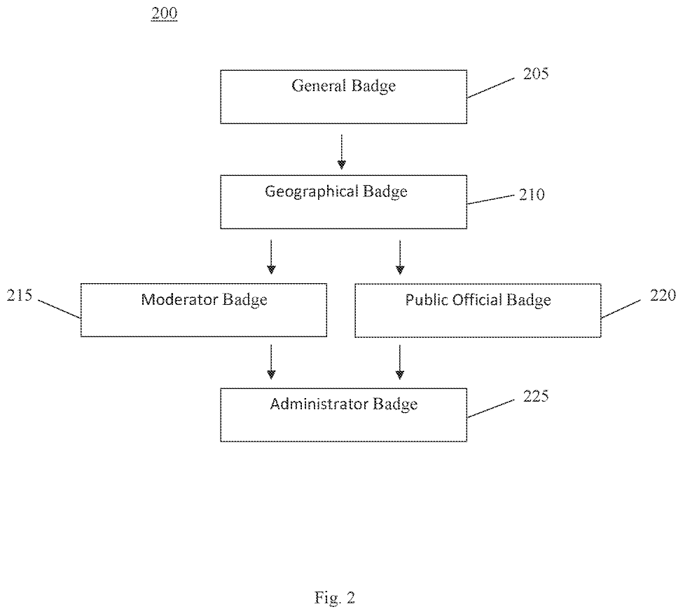

Politics are geographically based and a geographic verification step 115 may include a request to use the location of the device of the user. At geographic verification step 115a home address may be requested or, alternatively, a home address may be requested during the request for demographic information step 125. Once an address is input the input address is verified to be a real address. Once verification that the address is real. The processor requests access to the GPS in the device associated with the user. The processor then checks the current location of the device of the user and if the user is near or within a predetermined distance from the entered address the geographic verification step 115 is complete. The determination of the geographic location of the user aids in determining a level of access a user has to the political information hub, which is referred to as badges 120 associated with a particular user Access may include adding or deleting or editing posts or adding, deleting or editing comments and may be determined by badges 120 associated with a particular user (e.g., a user with one of badges 120 may add, delete or edit comments but not add, delete or edit posts). Changes including editing, adding, or deleting are all made apparent to the users. Many, if not all, of the changes may be undone by each individual user. Badges 120 are further described in FIG. 2. The political information hub may also include a social media component in which each user has friends, groups, messages, and unique badges. Demographic information 125 may be required throughout the processes that may include but is not limited to date of birth, political affiliation, sex, address, sexual orientation, religion, marital status, race, number of children.

Many, if not all, demographic information 125 can be optional. At the same time, as more information given regarding demographics, the more specific information can be for the user. For example, suppose a political issue arises that affects only people in a certain geographical location, such as a zoning issue. Voters in that geographic location may be sent a poll to inquire about their sentiments concerning the zoning issue via the political information hub. Without an address listed under the demographic information 125 a poll may not be received by the user even though the user resides in that specific location. This also informs elected officials of how their constituents of different demographics feel about the issues. Another optional step that may be included in demographic information 125 is a questionnaire that may aid in determining where on the political spectrum a user lies, which may also be referred to as a political ideology test 130 which may be relevant for voting in certain primary races in different voting districts. After the questionnaire there may be pictorial and/or graphical representation of the results of the questionnaire and how the user compares with others in the same geographical area.

FIG. 2 illustrates a flowchart for a method 200 of providing diverse levels of access (badges) to the political information hub to users. This is an exemplary method of allowing access to the political information hub. Access may include the ability to add, delete, and edit content within the political information hub. The political information hub may include governmental information from multiple different sites to allow centrally located information and at least a link may be provided in the hub that allows the user a central location to find answers to the political environment. The political information hub may provide a focused, unbiased, transparent, and unique user-based content/moderation. As a result, the changes made at any level of access may be made available to the users. Since the moderation may be user-based content/moderation the level of access a user is given is important. A first level of access may be denoted by general badge 205.

General badge 205 access may allow a user to read content including posts, comments, and 3^{rd} party political information but may have no ability to post or comment. Alternatively, those with general badge 205 permissions may only be able to view posts but not view the comments. Another alternative is that user with general badge access may be able not only view but to submit comments and posts to any place in or outside the voting district of the user. At the same time, another user may choose to filter out all comments and posts from those outside the voting district. The ability to flag posts one finds offensive may be given at any badge level, including general badge 205. A user may choose to only view content that receives less than 10% flags by those that reviewed that content. This content flag level may be adjusted by the user. The level of access or badges given to the user may be based on demographic information 125 and or geographic information 115 provided during the registration process. The badges or badge levels may also be influenced by a user's behavior or interaction with the political information hub, including what comments are made and/or the number of times logged on to the site etc.

Another badge level may include geographical badge 210 after the user has provided a verified address. To achieve this badge level geographic verification 110 may be required. Geographic badge 210 may allow the user to post and comment on issues, posts, or other content relevant to a geographic area. This geographic area likely includes the geographical area in which the user has rights to vote. For example, if the city council is looking to change a zoning designation from a commercial area to a high-density residential area within the geographic voting area of the user, information provided by the political information hub may be available to the user or may be flagged for the user. The user, as a result, may be provided a location to submit comments or make posts concerning the upcoming zoning changes being explored or voted on by the city council.

A geographic badge 220 may not necessarily limit what a user can follow. For example, even though a user lives in the suburbs outside a greater metropolitan area the user is often affected by the political outcomes of the greater metropolitan area. As a result, the user may follow the politics of the greater metropolitan area even though it is outside the user's geographic voting district and may be beyond the geographical badge 220. At the same time, any user following the politics of the greater metropolitan area may elect to only view comments made by those that reside within the greater metropolitan area using a filter. Further, that same user may use a filter to view comments and/or posts by those who reside in both the greater metropolitan areas and surrounding suburbs, while excluding users in the rest of the state.

A user may not be confined to only follow those within the user's voting district. For example, if a user lives on the border of two other states the user may be able to follow comment and post concerning each of the two other states outside the user's voting district. Moreover, the user may be able to receive alerts if political activity occurs in these other states. This may be important if a person has a second home in an area outside the voting district of the user's primary residence. It would be beneficial for the user to know about a town hall meeting taking place concerning a new road being proposed that would cut through the property of the user's second home.

Another badge levels may include moderator badge 215 and public official badge 220. Even though access of each badge may be different one badge is not necessarily hierarchically superior to the other. Moderator badge 215 may designate a moderator who has access to edit content but may be limited to editing content of those users who reside in a geographical voting area or, alternatively may be unlimited in the right to edit content outside of the geographical voting location of the user. For example, if a user with geographical badge 210 submits a post that is a duplicate of another post a user holding the moderator badge 215 may have permissions to combine the duplicate posts and may further notify the users that the post has been combined. Furthermore, moderator badge 215 may have the ability to analyze survey data and process it in visual representations and statistical compilations. Though each badge level may have the ability to add and edit content, other users may have the ability to see, rate, and discuss the history of every revision addition or edit that occurs within the site.

Public officials may be given greater permissions to provide their thoughts to their constituency as elected officials. As a result, public official badge 220 is a badge level that may allow greater permissions to submit material. For example, a user with public official badge 220 may be granted permissions to make a comment that is provided to users who are beyond the geographical voting area which is represented by the public official. For example, if a neighboring district passes a bill to raise taxes and a user with public official badge 220 in the neighboring district wishes to make a comment of why it is a bad idea can do so, the public official may have permissions to post such information based on public official badge 220 even though the issue is not germane to the public official's elected responsibility. Moreover, users with public official badge 220 may be able to add content without review from users with moderator badge. One of the limitations of having a badge level of public official 220, is that the public official may not be able to remain anonymous and may be required to include title such as councilman when acting/commenting/posting in his role as an elected official. Additionally, another user who may be able to receive the badge level of public official 220 may be a user who is running for office. Similarly, this user may also be banned from using an alias and must use their real name and identify what office the user is running for. Lastly the highest access badge may be administrator badge 225. The administrator may have access to edit post without restriction on geographical location with full moderation authority. As described above these are some of the few types of badges available to be implemented. Other badges are possible and may include badges for journalists, pundits, accredited users, organization etc.

Furthermore, a general badge user 205 may have the ultimate say in what content was edited and by whom it was edited. For example, a user may choose to view all posts without the editing of those with moderator badge 215. Another example is a general badge user 205 may choose to only view content posted by a user with a public official badge 220. Most if not all edits or alterations to the political information hub are intended to be transparent and may be user controlled.

The political information hub may use information from one or more 3^{rd} party source to provide the user with a one-stop location for political information. Each of the 3^{rd} party sites may use a different format to interface the information to a user. The 3^{rd} party information received by the political information hub system may be standardized by the system as it is incorporated into the political information hub system. This provides the user with a user friendly standardize interface. This standardized formatting allows a user to seamlessly move between 3^{rd} party political information and information provided by the political information hub system. This may further allow the user to more easily locate the desired information.

The standardized formatting may include but is not limited to font style background, tags, tables, text effect, font styling etc. Further, formatting may include grouping like parts from various 3^{rd} party sites. For example, a user may be searching for a public official in the user's particular voting district. The system may group all public official in one location such that a public official and find both a local city counsel member and governor of the state in one location through standardization. This may occur because through standardized formatting the public official in various 3^{rd} party sources were grouped together in one location on the political information hub.

Some of the standardized formatting may include an interface that is concise and user friendly that includes a design that is functional on any sized electronic screen. For example, the system may include a horizontal navigation bar featuring an exemplary nine different types feed namely public issues, bills, user initiatives, meeting and elections, public officials, courts, offices and departments, groups and cooperative, and special interest. The standardized formatting may further include related content found within the site within posts and headlines that is swipable or scrollable. Moreover, a user may have the ability to highlight sections of content and make comments. These highlights and comments may be viewable to other users specifically if it is dealing with bias and/or accuracy. Standardized formatting for the site may be different between different sized electronic device to accommodate the different screen sizes. For example, there may be a different formatting for a desktop computer as compared to a mobile phone. That being said, information received from 3^{rd} party sites may match the formatting of the different sized screens respectively.

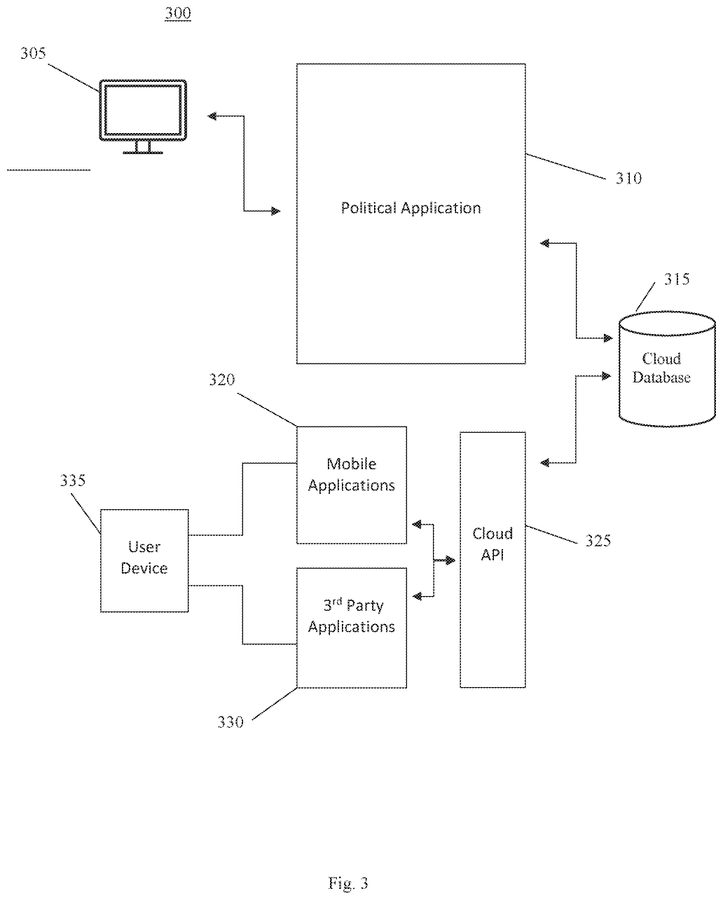

FIG. 3 illustrates an exemplary multicomputer network system 300 that provides user device 335 access to political information data. Multicomputer network system 300 implements a multi-device digital processing system including a processor 305. Processor 305 may be implemented in a computing device. Examples of computing devices include desktop computers, laptop computers, tablets, game consoles, personal computers, notebook computers, and any other electrical computing device with access to processing power sufficient to interact with multicomputer network system 300. Processor 305 may include software and hardware modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within processor 305 may be used to execute the various political applications, methods, or algorithms disclosed herein independent of other devices disclosed herein.

A user of processor 305 may use processor 305 to access a political application 310 which may be executed on processor 305 or may be executed as a web-based application on one or more server computing devices implemented within multicomputer network system 300. Political application 310 may provide a user with access to an electronic table configured to receive data values from a user of processor 305. The electronic table may perform mathematical calculations on the various data values received from the user of processor 305. The one or more server computing devices may include cloud computers, super computers, mainframe computers, application servers, catalog servers, communications servers, computing servers, database servers, file servers, game servers, home servers, proxy servers, stand-alone servers, web servers, combinations of one or more of the foregoing examples, and any other computing device that may be used to execute a political application 310 and interface with both processor 305 and cloud database 315. The one or more server computing devices may include software and hardware modules, sequences of instructions, routines, data structures, display interfaces, and other types of structures that execute server computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within one or more server computing devices may be used to execute the various methods or algorithms disclosed herein, and interface with processor 305 and cloud database 315.

In one embodiment, cloud database 315 includes one or more volatile and non-volatile memory devices, storage units, and non-transitory computer-readable storage media. Cloud database 315 maintains data related to political application 310. Thus, a user of processor 305 may interact with political application 310 to create a political information and store various types of data within cloud database 315 including cell values, formulas, political information formatting, user and file privacy settings, tag data, and any other data related to a political application 310. “Tags,” or tag data, represent cells in a spreadsheet, ranges of cells in a spreadsheet, or collections of values that are the result of some derivation of cells in a spreadsheet or existing tags, that have been given human-readable names based on a contextual analysis of the meaning of the data or assignment of a meaning by a user. Cloud database 315 may maintain a list of tags that have been created by users of multicomputer network system 300 such that every tag may be readily discoverable by any user of multicomputer network system 300. The list of tags may include a simple list, a table, a hash/lookup table, a collection of multiple tables (e.g., separate lists from across multiple files), and any other collection of organized data. The process of creating tags, performing the contextual analysis on the meaning of data, and a further explanation of the use of tags within a political application 310 will be described in further detail below.

In one embodiment, processor 305 may access political application 310 via an internet connection to one or more server computing devices executing political application 310. Any suitable internet connection may be implemented including any wired, wireless, or cellular based connections. Examples of these various internet connections include implemented using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication between user device 305, one of more server computing devices executing political applications 310, and cloud database 315.

Multicomputer network system 300 may further include a user device 335 that may be associated with a user in order to provide the user with access to political information functionality in a mobile environment. User device 335 may be implemented by any electronic device, such as a smart phone, a tablet, a personal computer, a music storage and playback device, a personal digital assistant, electronic gaming device or any other user device capable of implementing an application 325 or a 3^{rd} party application 330. Application 325 may implement a political information functionality in a manner similar to that of political application 310. Alternatively, or in addition, the user device 335 may also provide access to 3^{rd} party application 330 which can be provided with access to the full database of traditional political information data if properly authenticated and approved. 3^{rd} party application 330 provides access to the traditional political information data but on a limited basis in order to ensure the confidentiality of the underlying data. Both of application 325 and 3^{rd} party application 330 may have access to cloud API (Application Program Interface) 335 which may provide access to an authenticated user's tag data 340. In this embodiment, tag data 340 may be stored as a part of cloud database 315 except that tag data 340 is maintained to preserve user, file, and privacy data according to the user's instructions. Tag data 340 may also be stored separately to potentially limit access to non-tag data stored within cloud database 315.

The user device 335 may access application 325 or 3^{rd} party application 330 via any suitable internet wired, wireless, or cellular internet connection. Examples of these various internet connections include implemented using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication between the user device 335 and application 325, and 3^{rd} party application 330.

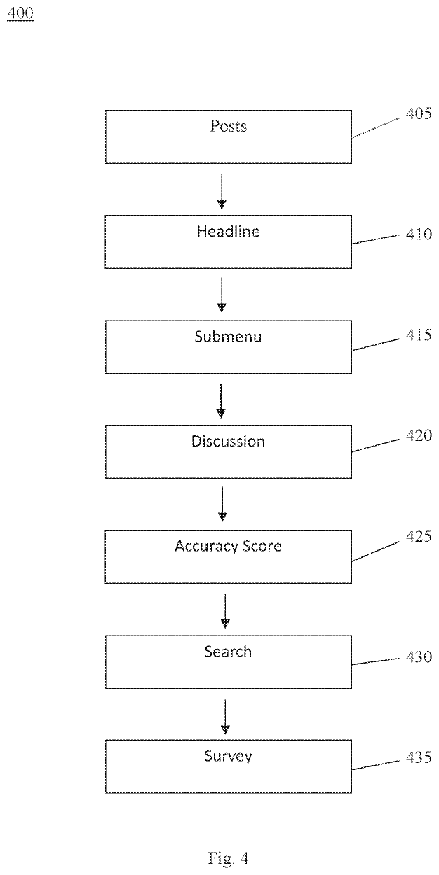

FIG. 4 illustrates a flowchart for a method 400 of user posted political information to the political information hub. As described above in FIG. 2 a user with an appropriate badge level may manually upload post 405 on the site using a user device. Alternatively post 405 may be made automatically uploaded by a processor using information found on 3^{rd} party governmental sites. For example, a new bill may be brought to before the state legislature. In this example, that bill may be placed as an inserted as a post 405 on the political information hub automatically or by a user.

Post 405 may include a headline 410, subpages 415, discussion 420, and an accuracy score 425. Each post may be associated with a region and can be filtered to show feedback form certain voting district. Post headline 410 may include a title and a small description of what the post entails. Each headline 410 may contain a unique layout based on the type of post 405 that allows the user to scroll a semi-randomized feed of related headlines. Some of the post 405 types that may include a unique layout are public issues, bills, user initiatives, meetings, elections, public official information, courts, offices and departments, cooperatives, and special interest groups. Unique layouts for headlines for additional headline 410 types may be included. A swappable information blurb may be included below the headline that may include related press, bills, or more. Moreover, the blurb may include one or more top comments.

To further illustrate, examples of post 405 may include public issues that may have the ability to combine multiple issues into one overarching issue to access related resources discussing the overarching issue. Post 405 of a bill may include a history of the bill, committee revision and who voted for and against the bill. Also, post 405 of bill may include visual representations of votes according to the senate/house seating or according to voting districts and demographics. Moreover, post 405 of a bill may include a visual representation of a timeline of bill vote history comparing constituents and leaders and an ideology chart of why/how people voted for the bill. The post 405 of a bill may include the positive and negative aspects of a bill and may further include top comments.

Similar to post 405 of a bill, a user initiative may have similar visuals and indication of public officials who support the initiatives. The user initiative feature provides an opportunity for a user to draft a piece of legislation and present it to other concerned users on the political information hub. The drafter of the legislation can then use the political information hub get feedback from other users through comments or posts. As the popularity of the drafted legislation increases the drafter may be able to find a legislative official who may be willing to sponsor the bill before the appropriate legislative authority. Where the bill is more appropriate as a citizen's initiative, the bill may form the basis for an initiative that is presented to voters following a real world petition drive.

In some embodiments, other users may be able to “upvote” the bill or may be able to financially sponsor the bill via micro donation. A bill that receives a set number of upvotes or sufficient sponsorship may then be uploaded onsite to be further edited by an in-house attorney to include the appropriate language.

Post 405 may include one or more distinctive meeting feeds that allow for town hall meetings, committee meetings, caucus meetings, candidate debates, political conventions, conferences etc. These meetings may include an agenda with a timeline or an agenda. Notifications of these meeting may be set up on the system to alert the user of an event or a portion of the event that interests the user. Furthermore, these meetings may be storable for future viewing which could include an expiration date for viewing a particular meeting. The livestream and stored meetings may be time stamped and broken up to different agenda segments. Additionally, these livestream and stored meetings may have their own comment section, summaries, vote history, and ratings.

A public official post 405 may include a campaign mode toggle to show campaign status, donation goals, debates, and how a public official's votes differ from that of their constituents etc. It may have visual representations to compare candidates to one another on various levels such as donations stances on different issues, education, years of public service, years in the community, voting, etc. Furthermore, users may elect to use a campaign mode toggle that enables the user to focus on information concerning a specified campaign. The campaign mode may allow the user to focus on a particular individual or a certain race. There may be included a loyalty rating comparing how the public official voted compared to constituents. Further, the courts post 405 may include judicial performance evaluation on each judge. This may include a visual of a performance evaluation history of a judge that may compare it to the performance evaluation history of other judges.

Government offices and departments may actuate a post 405 that incudes upcoming events budgetary consideration employees and meeting times and schedules. But not all post 405 need to be government officials. Individuals may form their own coalition, group, and/or cooperatives under common interests. These may allow similar arrangement as other posts 405 described above. The coalition, group, and/or cooperatives may be open, or membership based and can be accredited as legal entities. Specifically, special interest groups may actuate posts 405 that include visual charts to show contribution and lobby history.

Posts 405 may be sorted according to their popularity, trending, date, topic, user history, post by a particular user etc. Upon sorting posts 405 may allow the user to scroll and/or toggle through the sorted posts 405. Posts 405 may further include a submenu 415 that may contain an outline of key features included in post 405 wherein upon selecting an item on the submenu a user may be taken to the location of where the selected item is discussed. Submenu 425 may also include a comment section where a user can view the comments section without having to scroll through the entire post to find the comments at the end.

Discussions 420 and surveys 435 may accompany each post 405 on the political information hub site. Each post 405 may have its own forum with unique discussions 420. Discussions 420 may be sorted by several factors including but not limited to popularity, trending, date, user, number of responses, topic. Furthermore, each discussion 420 may have its own moderation tab where users can see other discussions 420 about revisions, content added, flagged posts, and survey 435 conduction and aggregation.

Subdiscussion for topics may also be included in discussions 420 where in the subdiscussion may include press headlines, bills, initiatives, resources, meetings/events, etc. Comment filters may be applied to discussion 420. These comment filter may hide comments from user without geographic badge 201 or users with general badge 210 as shown in FIG. 2. A user may also have the ability to flag a comment because of abusive language. For example, a user may choose to hide comments where fifty percent of the users with moderator badge 215 have flagged the comment as abusive. Users with moderator badge 215. The ability to flag discussions may be giver to a user with any badge described in FIG. 2. Alternatively, access may be given to those who have mediator badge 215 or administrator badge 225 or any other combination of badges.

An additional feature is that a user can highlight and review sections for accuracy, and bias. The system may be set up to highlight lines common words used in posts 405 that contain biases. A user may have the ability to vote if an article is politically more left leaning or more right leaning. A chart may indicate where users view. Post 405 may be highlighted by a user and comments may be included siting the highlighted area. Rating for accuracy and bias may be done by the users but also may be done by an official rating agencies. All ratings are up for discussion by other users.

At the end of Post 405 the user is invited to give accuracy score 425. The accuracy score may be scaled form 1-10 where 10 is the most accurate and 1 is a highly inaccurate. Accuracy score 425 may further be used to filter posts 405. For example, if a user only wants to read articles that average an accuracy score 425 of 8 or better the user may use search 430 to find the corresponding posts 405. Search 430 may further be filtered by topic, author, public official, accuracy score, popularity, most commented, individual who initiated the post etc. may be done through the search option. To further provide information about the user and to give an opinion about post 405 a survey may also be placed at the end of post 405.

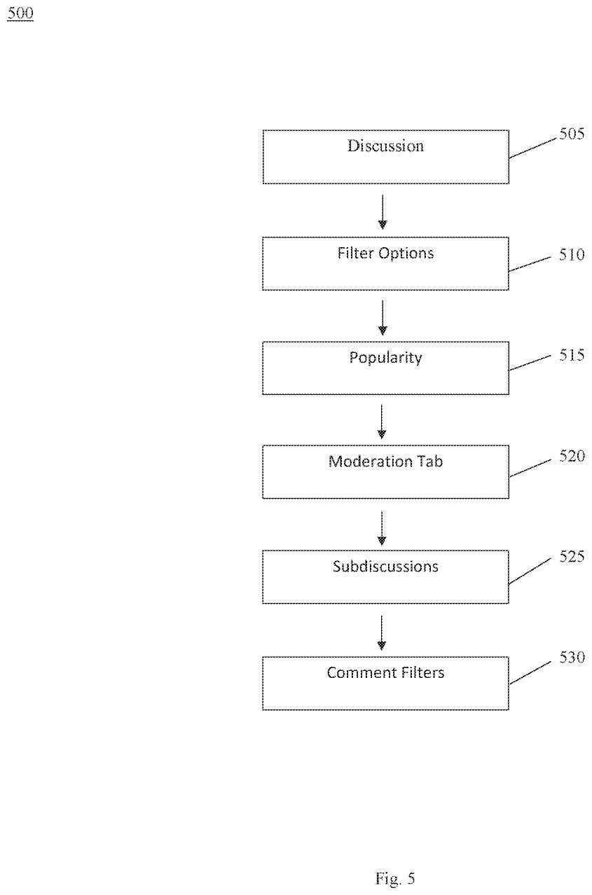

FIG. 5 illustrates a flowchart for a method 500 of posting and accessing discussions posted to the political information hub. Each post 405 may have its own forum with unique discussions 505 and may be filtered through filter options 510. Filter options 510 may include but are not limited to popularity 515, trending, date, user, number of responses, topic. Furthermore, each discussion 505 may have its own moderation tab 520 where users can see other discussions 505 about revisions, content added, flagged posts, and survey 435 conduction and aggregation. Subdiscussion 525 for topics may also be included in discussions 420 where in the subdiscussion may include press headlines, bills, initiatives, resources, meetings/events, etc.

Comment filters 530 may be applied to discussion 505. These comment filter may hide comments from user without geographic badge 210 or users with general badge 205 as shown in FIG. 2. A user may also have the ability to flag a comment because of abusive language. For example, a user may choose to hide comments where fifty percent of the users with moderator badge 215 have flagged the comment as abusive. The ability to flag discussions may be given to a user with any badge described in FIG. 2. Alternatively, access may be given to those who have mediator badge 215 or administrator badge 225 or any other combination of badges. A moderation tab 520 may include subcategories including revisions, survey, flagged comments, and ratings. Moderation tab 520 is where on may view the results of the revisions, surveys, flagged comments, and ratings for a particular post 405. Subdiscussions 525 may be an outcropping of post 405 for example a post concerning a ban on a local sporting goods store that sells firearms may spark a subdiscussion about the second amendment rights.

Comments seem to be the most inflammatory statements made online as a result a user may flag vulgar language or inappropriate comment. As a result, a user may use comment filter 530 to only view comments users flagged less than 25% of the time. Comment filter 530 can also filter by popularity 515, trending, date, user, number of responses to the comment, topic.

Additionally, a ballot feature may be available on the political information hub. This ballot feature may allow the user to search for and sort specific offices and/or referendums. The user may also sort by aggregated political referendums from 3^{rd} party sites. The user may search polls that include those conducted on site and 3^{rd} party polls conduct offsite but collected and made available onsite. This collection for 3^{rd} party polls may be manually collected by a user with the appropriate badge level or automatically by a processor programed to collect polls from 3^{rd} party sites. This ballot feature may also provide an onsite location where a user can vote for a candidate or issues using different types of voting that may include ranked choice voting, approval voting, proportional representation voting. This ballot feature may also allow a user to sort by ideology, demographic, contributions, overall polls, and or an ideology chart. This feature may be enhanced as more and more users are categorized by the ideology test 130 and provide demographic information 125 as described in FIG. 1. Polls may broadly indicate ballots, surveys, and/or questionnaires. The results of the polls may specify the geographic location or the demographic information 125 in place of the name of the user to protect the identity of the user. Separation of polls may be done according to a badge level or device verification 110 and/or geographic verification 115. The system may include an additional education feature that may include historic and contemporary details about politics and may answer questions for both children and adults. This education feature may include public official biographies, statistics, and other information. For example, the education feature may provide information on the history of the state legislature and a statistical analysis of the performance of a current or past public official.

An additional feature that may be included maps and redistricting that shows the current maps and any redistricting proposals. This feature allows users to compare district boundaries to its voting district. The map may further include information concerning demographics, voter registration, and voter tendencies in each individual district. User may also be able to submit and/or vote on redistricting initiatives and referenda.

The foregoing description is presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system comprising:
a processor associated with a server computer which is receiving login information from a device associated with a user including a confirmed address associated with a user;
requesting access to a physical location of the device associated with the user;
verifying the physical location of the device associated with the user is within a predetermined distance from the confirmed address received by the processor associated with the server computer with the login information;
identifying one or more voting district associated with the confirmed address; and
transmitting a message to the device associated with the user with political information relevant to the voting district with the user based on the physical location of the device and the confirmed address.

2. The system of claim 1, wherein the processor receives political information within the voting district from one or more third-party sources and standardizes the format of information received from the one or more third-party source.

3. The system of claim 2, wherein the third-party information is sent to the device associated with the user in the standardized format.

4. The system of claim 1, wherein the processor receives a post form a device associated with the user.

5. The system of claim 4, wherein the post received is given an accuracy score by a second device associated with a second user.

6. The system of claim 4, wherein a poll is transmitted to a device associated with the user subsequent to the post.

7. The system of claim 5, wherein the processor receives a comment from the second device associated with a second user.

8. The system of claim 4, wherein the political information includes a filter.

9. The system of claim 8, wherein the device associated with the user selects the filter all comments but comments from voters in their voting district.

10. The system of claim 8, wherein the device associated with the user selects to filter all posts but posts from public officials.

11. A method comprising:
receiving, by a processor associated with a server computer, login information from a device associated with a user including a confirmed address associated with a user;
requesting, by the processor, access to a physical location of the device associated with the user;
verifying, by the processor, the physical location of the device associated with the user is within a predetermined distance from the confirmed address received by the processor associated with the server computer with the login information;
identifying, by the processor, one or more voting district associated with the confirmed address; and
transmitting, by the processor, a message to the device associated with the user with political information relevant to the voting district with the user based on the physical location of the device and the confirmed address.

12. The method of claim 11, wherein the processor receives political information within the voting district from one or more third-party source and standardizes the format of information received from the one or more third-party source.

13. The method of claim 12, wherein the third-party information is sent to the device associated with the user in the standardized format.

14. The method of claim 11, wherein the processor receives a post form a device associated with the user.

15. The method of claim 14, wherein the post received is given an accuracy score by a second device associated with a second user.

16. The method of claim 14, wherein a poll is transmitted to a device associated with the user subsequent to the post.

17. The method of claim 15, wherein the processor receives a comment from the second device associated with a second user.

18. The method of claim 14, wherein the political information includes a filter.

19. The method of claim 18, wherein the device associated with the user selects the filter all comments but comments from voters in their voting district.

20. The method of claim 18, wherein the device associated with the user selects to filter all posts but posts from public officials.
